(19) United States
(12) Patent Application Publication
(10) Pub. No.: US 2012/0233166 A1
(43) Pub. Date: Sep. 13, 2012

(54) TAG INFORMATION MANAGEMENT APPARATUS, TAG INFORMATION MANAGEMENT SYSTEM,CONTENT DATA MANAGEMENT PROGRAM, AND TAG INFORMATION MANAGEMENT METHOD

(75) Inventors: Hayato Kato, Nagoya-shi (JP); Hiroaki Kawasaki, Nagoya-shi (JP); Yutaka Maruyama, Nagoya-shi (JP); Kenji Takahashi, Nagoya-shi (JP)

(73) Assignee: Buffalo Inc., Nagoya-shi (JP)

(21) Appl. No.: 13/293,729

(22) Filed: Nov. 10, 2011

(30) Foreign Application Priority Data
Nov. 11, 2010 (JP) 2010-252924

(51) Int. Cl. G06F 17/30

(52) U.S. Cl. 707/737; 707/E17.089

(57) ABSTRACT

A content data management apparatus that manages tag data indicating attributes relating to content data, comprising: an extraction section that extracts positional information indicating geographic positions associated with the content data and time information indicating time points associated with the content data, the positional information and the time information being attached to the content data; a speed computation section that computes speeds associated with the content data, based on the positional information and the time information extracted by the extraction section; and a grouping section that groups the content data, based on the speeds computed by the speed computation section.

### CROSS REFERENCE TO RELATED APPLICATIONS

This application is based upon and claims the benefit of priority from prior Japanese Patent Application No. 2010-252924, filed on Nov. 11, 2010; the entire content of which is incorporated herein by reference.

### BACKGROUND OF THE DISCLOSURE

1. Technical Field

The present invention relates to a content data management apparatus, a content data management system, non-transitory computer readable medium, and a content data management method, for managing content data.

2. Description of the Related Art

In recent years, since prices of recording mediums are getting lower and capacities of recording mediums are getting larger, users hold a large amount of data (hereinafter, called as contents data) formed of contents such as image data, voice data, or document data. Thus, appropriate management of a large amount of content data is required.

For example, according to the Description of JP-A-2003-259285, pieces of image data that are acquired as images in the same geographic position are grouped based on positional information which is tag data obtained at the time of image acquisition.

However, according to the technique described in the above mentioned JP-A-2003-259285, such pieces of image data as having the same geographic position but having poor relationship among themselves, too, are included in the same group. To overcome this drawback, it is urgently needed to provide a novel technique for appropriately grouping content data.

### SUMMARY

According to a feature of the present disclosure, there is provided a content data management apparatus (set top box 10) that manages tag data indicating attributes relating to content data including: an extraction section (tag data extraction section 154) that extracts positional information indicating geographic positions associated with the content data and time information indicating time points associated with the content data, the positional information and the time information being attached to the content data; a speed computation section (speed computation section 156) that computes speeds associated with the content data, based on the positional information and the time information extracted by the extraction section; and a grouping section (grouping section 157) that groups the content data, based on the speeds computed by the speed computation section.

The content data management apparatus computes speeds based on positional information and time information that are items of tag data assigned to content data, and group's content data based on the speeds. In the case where relationships among items of content data can be specified by using speeds, grouping can be performed as to content data based on the speeds.

Another feature of the present disclosure is that the grouping section acquires information associated with the content data, based on the positional information, and groups the content data, based on the associated information.

Another feature of the present disclosure is that the content data management apparatus includes a first display processing section (display processing section 158) that displays images belonging to the respective groups obtained through grouping performed by the grouping section.

Another feature of the present disclosure is that the content data management apparatus includes a second display processing section (display processing section 158) that displays images belonging to any one of the groups, the images being acquired at different times and the grouping being performed by the grouping section.

According to another feature of the present disclosure, there is provided a content data management system that manages content data, including: an extraction section that extracts positional information indicating geographic positions associated with the content data and time information indicating time points associated with the content data, the positional information and the time information being attached to the content data; a speed computation section that computes speeds associated with the content data, based on the positional information and the time information extracted by the extraction section; and a grouping section that groups the content data, based on the speeds computed by the speed computation section.

According to still another feature of the present disclosure, there is provided a non-transitory computer readable medium that stores programs for managing content data, the computer readable medium storing a program for causing a computer to execute a step of extracting positional information indicating geographic positions associated with the content data and time information indicating time points associated with the content data, the positional information and the time information being attached to the content data; a step of computing speeds associated with the content data, based on the positional information and the time information extracted by the extraction section; and a step of grouping the content data, based on the speeds computed by the speed computation section.

According to yet another feature of the present disclosure, there is provided a content data management method used for a content data management system for managing content data, comprising the steps of extracting positional information indicating geographic positions associated with the content data and time information indicating time points associated with the content data, the positional information and the time information being attached to the content data; computing speeds associated with the content data, based on the positional information and the time information that are extracted; and grouping the content data, based on the computed speeds.

### BRIEF DESCRIPTION OF THE DRAWINGS

FIG. 1 shows the structural of a set top box according to an embodiment of the present invention.

FIG. 2 shows the structure of image data used in the embodiment shown in FIG. 1.

FIG. 3 shows one example of grouping of image data.

FIG. 4 shows one example of a map image indicating a group of content data.

FIG. 5 is a flowchart showing an operation of the set top box shown in FIG. 1.

FIG. 6 illustrates the entire schematic structure of a content management system as another embodiment of the present invention.

### DETAILED DESCRIPTION

Next, embodiments of the present invention will be described with reference to the drawings, in the following order named: (1) structure of set top box, (2) operation of set top box, (3) operations and advantageous effects of set top box, and (4) other embodiments. Throughout all figures, the same or similar constituent elements are designated by the same or similar reference numerals.

### (1) Structure of Set Top Box

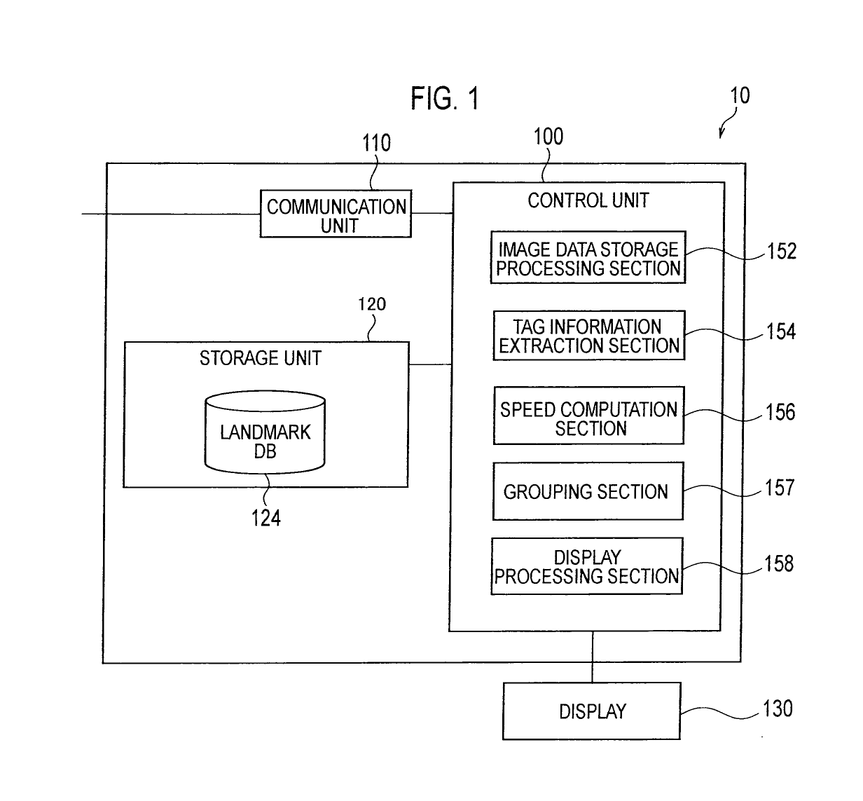

FIG. 1 shows in block diagram the structure of a set top box 10 as a content management apparatus. The set top box 10 shown in FIG. 1 receives image data transmitted from a digital camera that is an external device (although not shown). The set top box 10 includes a control unit 100, a communication unit 110, a storage unit 120, and a display 130.

The control unit 100 includes a CPU, for example, and controls a variety of functions performed by the set top box 10.

The communication unit 110 is a LAN card, for example, and a MAC (Media Access Control) address is assigned to the LAN card. The communication unit 110 is a communication interface that communicates with an external device, and communicates with an external communication apparatus via a communication network. The storage unit 120 is a NAND flash memory, for example, and stores various pieces of information used for controls in the set top box 10. The display 130 displays a variety of images in accordance with instructions from the control unit 100.

The control unit 100 includes an image data storage processing section 152, a tag data extraction section 154, a speed computation section 156, a grouping section 157, and a display processing section 158.

The image data storage processing section 152 receives image data as content data that is transmitted from a digital camera, via the communication unit 110. Further the image data storage processing section 152 causes the storage unit 120 to store the received image data.

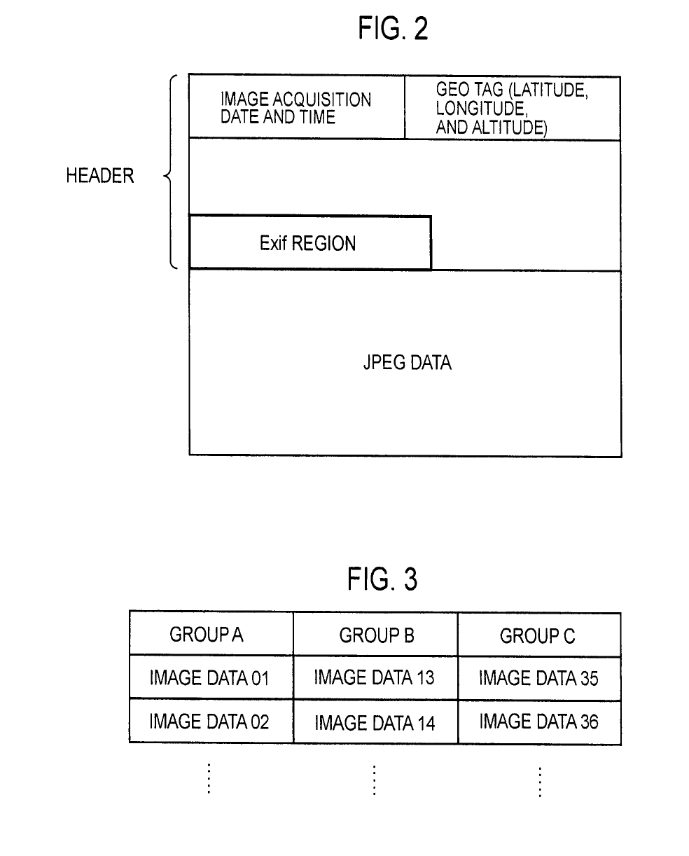

FIG. 2 shows the structure of the image data. The image data shown in FIG. 2 includes a header and JPEG (Joint Photographic Experts Group) data.

The header includes tag data indicating the attributes of the image data. The tag data indicates the attributes of the image data to be assigned at the time of image acquisition by means of a digital camera. In the embodiment, the tag data includes data) on the date and time of image acquisition (time tag data) and data) on the latitude, the longitude and the altitude of a position where an image is acquired (geo tag data).

In addition, the header includes the Exif (Exchangeable image file format) region. The Exif region includes a user ID that is the identification information of a photographer.

A description will be made with reference to FIG. 1 again. The tag data extraction section 154 extracts geo tag data, time tag data, and user IDs from the image data that is stored in the storage unit 120.

The speed computation section 156 selects that combination of geo tag data and time tag data which corresponds to a predetermined user ID. Next, the speed computation section 156 performs the processing operation of arranging image the data having the selected geo tag data and the time tag data in accordance with time that is indicated by the time tag data, i.e., in time sequence.

Further, the speed computation section 156 computes speeds on the basis of the combination of geo tag data and time tag data associated with the image data that are adjacent to each other in time sequence. Specifically, the speed computation section 156 computes the difference between the two items of geo tag data. The computed difference is the distance between the geographic positions (image acquisition positions) where the image data associated with the two items of geo tag data has been generated. Next, the speed computation section 156 computes speed by dividing the distance between two adjacent image acquisition positions by the time interval between the two time points associated with the two adjacent image acquisition positions. The computed speed is a movement speed at which a user has moved from one image acquisition position to another.

The speed computation section 156 computes a speed between the two image data, with respect to all of the image data. Further the speed computation section 156 generates grouping data which includes combinations of geo tag data and time tag data, and speeds computed on the basis of the combinations of the geo tag data and the time tag data.

Here, of all the combinations of geo tag data and time tag data that have been arranged in time sequence, a combination except at both the ends of the time-sequential arrangement can be employed for speed computation together with an immediately preceding combination and an immediately succeeding combination. That is, two different speeds are computed with respect to one combination of geo tag data and time tag data. Thus, the speed computation section 156 generates grouping data by grouping image data associated with higher speeds or lower speeds, these two different speeds being computed from combinations of geo tag data and time tag data. For example, in the case where after a user has moved on foot, the user moves by riding on a vehicle, the speed computation section 156 can group movements on foot into one group by grouping image data associated with lower speeds.

On the other hand, in the case where a user moves by train after image acquisition at a station, the speed computation section 156 can group movements by train into another group by grouping image data associated with higher speeds.

The grouping section 157 arranges grouping data in time sequence, based on the time tag data that is included in the grouping data. Next, if the difference between the speeds included in the two items of grouping data that are adjacent to each other in time sequence is within a predetermined range of values, the grouping section 157 groups the image data associated with the two items of grouping data into one group. On the other hand, if the difference in speed exceeds the predetermined range of values, the grouping section 157 groups the image data associated with the two items of grouping data into another group.

In grouping, further, altitude data of the geo tag data that are included in two items of grouping data may be referred to. In this occasion, if the difference between the speeds included in two items of grouping data that are adjacent to each other in time sequence is within a predetermined range of values and if the difference in altitude is within a predetermined range, then the grouping section 157 may group the image data associated with the two items of grouping data into one group. On the other hand, if the difference in speed exceeds the predetermined range of values, or if the difference in altitude is beyond the predetermined range, then the grouping section 157 may group the image data associated with the two items of grouping data into another group.

The grouping section 157 performs the processing operation described above, with respect to all of the grouping data, and groups the image data associated with the grouping data into either one of the two groups.

Next, the grouping section 157 reads out landmark data that is stored in a landmark data DB (Data Base) 124 installed in the storage unit 120. The landmark data is provided for each landmarked facility, and includes a set of latitudes and longitudes of outer edges of the facility.

The grouping section 157 acquires grouping data associated with the plural items of image data that are grouped into the respective groups.

Next, the grouping section 157 compares the geo tag data included in each item of the acquired group data, with interested landmark data, and determines whether or not the latitude and longitude that are included in the geo tag data are within the area of the landmark. If the result of the determination is that the latitude and longitude included in the geo tag data included in an item of grouping data are within the landmark area and that the latitude and longitude included in the geo tag data included in another item of grouping data do not fall within the landmark area, then the grouping section 157 classifies the image data associated with the one item of grouping data and the image data associated with another item of grouping data into different groups.

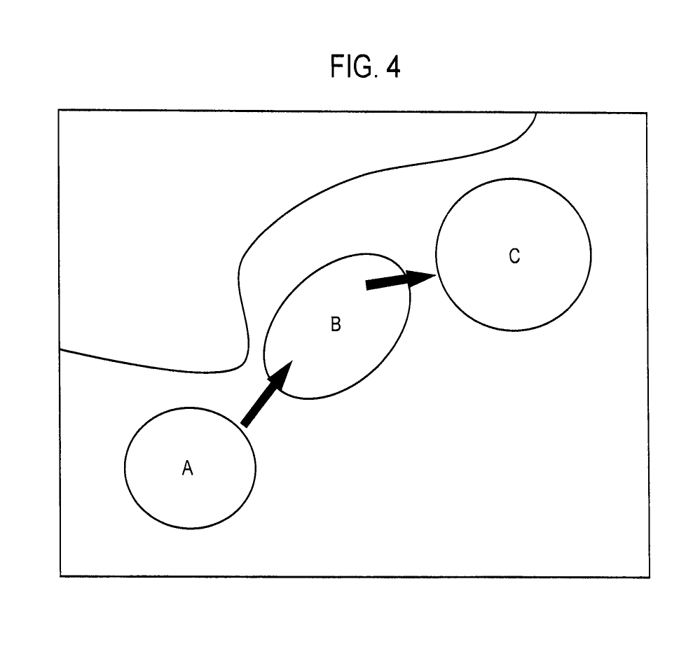

FIG. 3 shows one example of grouping of image data. As shown in FIG. 3, one item or a plurality of items of image data is associated with each group. The grouping section 157 causes the storage unit 120 to store group data that is obtained by associating group data with one or plural items of image data.

The display processing section 158 causes the display 130 to display a map image indicating the group (the image showing the area where the group exists), based on the group information stored in the storage unit 120. Moreover, the display processing section 158 causes the display 130 to display images indicating groups at different times.

Specifically, the display control section 158 sets a group region for each item of group information, based on geo tag data included in grouping data associated with the group information, recognizes the sequence of movements of a user from one group to another, based on time tag data included in the grouping data associated with each item of group information, and superimposes, on a map image, an image indicating a group image (the image showing the area where the group exists) and an image indicating the time-sequential movements of the groups (an arrow indicating the movement between the groups), and causes the display 130 to display the superimposed images on the map image.

FIG. 4 shows one example of the map image displayed on the display 130. FIG. 4 shows a case in which a group A, a group B, and a group C are set and then a user has moved sequentially from the group A through the group B up to the group C.

Further, when a user selects one group from in the map image by operating an operation unit (not shown) in the set top box 10, the display processing section 158 causes the display 130 to sequentially display images that correspond to image data that is include in the selected group.

### (2) Operation of Set Top Box

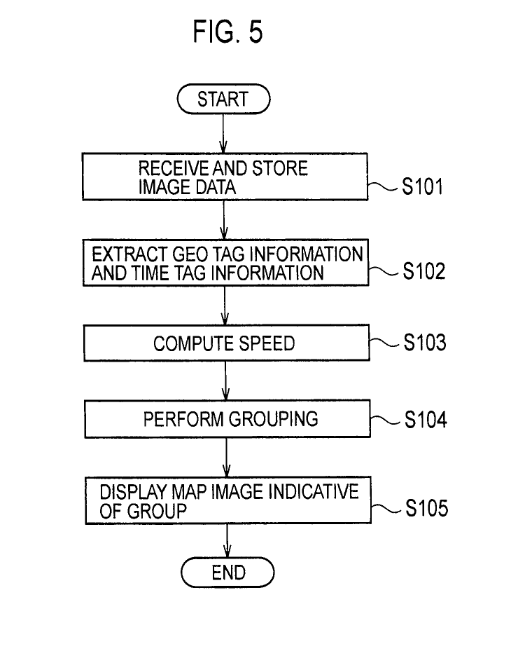

FIG. 5 is a flowchart showing the operation of the set top box 10.

In step S101, the set top box 10 receives and stores image data that is transmitted from a digital camera.

In step S102, the set top box 10 extracts the geo tag data and the time tag data that are included in the image data.

In step S103, the set top box 10 computes a speed, based on the extracted geo tag data and time tag data.

In step S104, the set top box 10 performs grouping of the image data, based on the computed speeds.

In step S105, the set top box 10 displays images indicating groups on the map image. The set top box 10 may display images indicating groups at different times on the map image.

### (3) Operations and Advantageous Effects

The set top box 10 of the embodiment extracts geo tag data and time tag data that are assigned to image data, and computes speeds based on the geo tag data and the time tag data. Next, the set top box 10 performs grouping of image data, based on the computed speeds, and displays the image indicating each group on the map image. In the case where items of image data can be associated with one another by referring to speeds, appropriate grouping can be performed as to image data on the basis of speeds.

### (4) Other Embodiments

As described above, while the present invention was described by way of embodiments, it should not be understood that these embodiments and drawings limit the invention. From this disclosure, a variety of substitutive embodiments, modifications and operational techniques will be obvious to one skilled in the art.

In the foregoing embodiments, the set top box 10 performs by itself the extraction of geo tag data and time tag data from image data, the calculation of speeds, the grouping of image data, and the display of image indicating groups. However, these processing operations may be shared and performed by a plurality of devices.

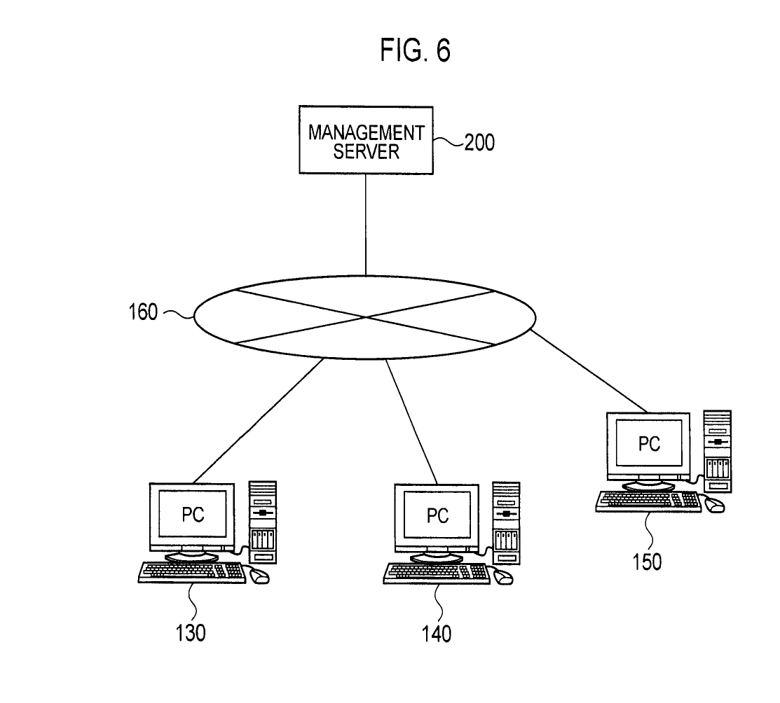

FIG. 6 illustrates the entire structure of a content management system. The content management system shown in FIG. 6 comprises a management server 200; a personal computer (PC) 130; a PC 140; a PC 150; and a communication network 160 for connecting the management server 200 with the PCs 130, 140 and 150.

In the content management system, the management server 200 and the PCs 130, 140 and 150 share the processing operations of the image data storage processing section 152, the tag data extraction section 154, the speed computation section 156, the grouping section 157, and the display control section 158 in the control unit 100 of the set top box 10 shown in FIG. 1.

Specifically, each of the control units of the PCs 130, 140 and 150 includes an image data storage processing section 152, a tag data extraction section 154, and a display processing section 158, and the control unit of the management server 200 includes a speed computation section 156 and a grouping section 157.

In this case, the image data storage processing section 152 in the control unit in each of the PCs 130, 140 and 150 receives image data, and causes the storage unit in each of the PCs 130, 140 and 150 to store the received data.

The tag data extraction section 154 in the control unit of the PC 130 to the PC 150 extracts geo tag data and time tag data from the image data that is stored in the storage unit.

Further the tag data extraction section 154 in the control unit of each of the PCs 130, 140 and 150 transmits the extracted geo tag data and the time tag data to the management server 200 via the communication network 160.

Upon receiving the transmitted geo tag data and the time tag data, the speed computation section 156 in the control unit of the management server 200 computes speeds based on the received geo tag data and time tag data. Next, the grouping section 157 in the control unit of the management server 200 performs grouping based on the computed speeds. Further, the grouping section 157 in the control unit of the management server 200 transmits information indicating a group of the image data associated with the geo tag data and the time tag data, to the PC 130˜the PC 150 via the communication network 160.

The display processing section 158 in the control unit of each of the PC 130˜the PC 150 displays a map image indicating a group, based on information indicating a group of the image data associated with the geo tag data and the time tag data.

While in the foregoing embodiments cases are described in which image data is employed as content data, the present invention can also be applied similarly to a case where another item of content data such as voice data or document data is employed.

Although not described in the above embodiments, a computer programs may be provided which causes a computer to execute the steps shown in FIG. 5. Further, such computer programs may be stored in a computer readable medium. The computer programs may be installed in the computer by using the computer readable medium. The computer readable medium having the computer programs stored therein may be a non-volatile recording medium. The non-volatile recording medium is not any specified recording medium, but may be a recording medium such as CD-ROM or DVD-ROM, for example.

As described heretofore , it should be understood that the present invention encompasses a variety of embodiments or the like which are not described herein. Therefore, the present invention is limited only by the claims attached hereto.

What is claimed is:

1. A content data management apparatus that manages tag data indicating attributes relating to content data comprising:
an extraction section that extracts positional information indicating geographic positions associated with the content data and time information indicating time points associated with the content data, the positional information and the time information being attached to the content data;
a speed computation section that computes speeds associated with the content data, based on the positional information and the time information extracted by the extraction section; and
a grouping section that groups the content data, based on the speeds computed by the speed computation section.

2. The content data management apparatus according to claim 1, wherein the grouping section groups the content data into the same group, when the speeds associated with the content data are within a predetermined range.

3. The content data management apparatus according to claim 1, wherein the grouping section acquires information associated with the content data, based on the positional information, and groups the content data, based on the associated information.

4. The content data management apparatus according to claim 1, further comprising a first display processing section that displays images belonging to the respective groups obtained through grouping performed by the grouping section.

5. The content data management apparatus according to claim 1, further comprising a second display processing section that displays images belonging to any one of the groups, the images being acquired at different times and the grouping being performed by the grouping section.

6. A content data management system that manages tag information indicating attributes relating to content data, comprising:
an extraction section that extracts positional information indicating geographic positions associated with the content data and time information indicating time points associated with the content data, the positional information and the time information being attached to the content data;
a speed computation section that computes speeds associated with the content data, based on the positional information and the time information extracted by the extraction section; and
a grouping section that groups the content data, based on the speeds computed by the speed computation section.

7. A non-transitory computer readable medium that stores a computer program for managing tag information indicating attributes relating to content data, the computer program causing a computer to execute the steps of:
extracting positional information indicating geographic positions associated with the content data and time information indicating time points associated with the content data, the positional information and the time information being attached to the content data;
computing speeds associated with the content data, based on the extracted positional information and the extracted time information; and
grouping the content data, based on the computed speeds.

8. A content data management method used for a content data management system for managing tag data indicating attributes relating to content data, the content data management method comprising the steps of:
extracting positional information indicating geographic positions associated with the content data and time information indicating time points associated with the content data, the positional information and the time information being attached to the content data;
computing speeds associated with the content data, based on the positional information and the time information that are extracted; and
grouping the content data, based on the computed speeds.
